(19) United States
(12) Patent Application Publication
(10) Pub. No.: US 2003/0058516 A1
(43) Pub. Date: Mar. 27, 2003

(54) Dynamic spectral equalizer and wavelength selective switch having extremely low polarization dependent loss and polarization mode dispersion

(76) Inventors: Bradley A. Scott, Silverado, CA (US); Robert G. Lindquist, Elmira, NY (US); Yimin Ji, Hudson, OH (US); Rui-Qing Ma, Painted Post, NY (US); John P. Kondis, Costa Mesa, CA (US)

Correspondence Address: Price, Heneved Copper, De' Witt & Litton, 695 Kenmoor, S.E., Grand Rapids, MI, 49501, US

(21) Appl. No.: 10/121,439

(22) Filed: Apr. 12, 2002

Related U.S. Application Data
(60) Provisional application No. 60/283,592, filed on Apr. 13, 2001.

(51) Int. Cl. G02F 1/03; G02F 1/07

(52) U.S. Cl. 359/246

(57) ABSTRACT

An optical system according to the present invention includes a beam polarization combiner for receiving first and second sets of input beams, and a reflective spatial light modulator having a plurality of individually activated modulating elements each corresponding to a respective one of the different wavelengths of the input beams. Each input beam is directed at a modulating element of corresponding wavelength with input beams of the first and second sets impinging upon the modulating element from respective first and second incoming paths. Each modulating element selectively changes the input beams such that the outgoing path for each reflected beam of each set is superimposed on the incoming path for the other set. The beam combiner receives the reflected sets of beams and directs them in different directions based upon their polarization. The optical system may be used in a wavelength selective switch or a dynamic spectral equalizer.

### CROSS-REFERENCE TO RELATED APPLICATIONS

This application claims the benefit of priority under 35 U.S.C. §119(e) for U.S. Provisional Patent Application No. 60/283,592 entitled “DYNAMIC SPECTRAL EQUALIZER AND WAVELENGTH SELECTIVE SWITCH HAVING EXTREMELY LOW POLARIZATION DEPENDENT LOSS AND POLARIZATION MODE DISPERSION,” filed on Apr. 13, 2001 by Scott A. Bradley et al., the entire disclosure of which is incorporated herein by reference.

### BACKGROUND OF THE INVENTION

1. Field of the Invention

The present invention relates to optical switches and dynamic spectral equalizers. More particularly, the present invention pertains to wavelength selective switches and dynamic spectral equalizers utilizing a spatial light modulator.

2. Technical Background

In the past two decades, fiberoptics have transformed the telecommunications marketplace. Initially, network designs included relatively low speed transceiver electronics at each end of the communications link. Light signals were switched by being converted into electrical signals, switched electronically, and reconverted into light signals. The bandwidth of electronic switching equipment is limited to about 10 GHz. On the other hand, the bandwidth of single mode optical fibers in the 1550 nm region of the electromagnetic spectrum is in the Terahertz range. As the demand for bandwidth increases exponentially, network designers have sought ways to exploit the available bandwidth in the 1550 nm region.

Dynamic spectral equalizers (DSEs) and wavelength selective switches (WSSs) provide valuable functionality to optical network applications by providing the ability to access and modify individual wavelengths that are carried on an optical fiber without using discrete wavelength division multiplexers (WDMs). Polarization dependent loss (PDL) and polarization mode dispersion (PMD) can severely degrade the quality of optical networking signals. As optical networking systems move to very high data rates, such as 10 Gbit/s and 40 Gbit/s, PDL and PMD become even more important. Therefore, DSEs and WSSs with very low PMD and PDL are extremely valuable.

Several approaches to providing a WSS are disclosed in commonly assigned International Publication No. WO 01/01173 A1. One of the approaches is shown in FIG. 1 and is described below. As shown in FIG. 1, a WSS 10 includes polarization beamsplitters 32a and 32b that separate input signals from a first input fiber (1s, 1p) and second input fiber (2s, 2p) into their parallel and orthogonal signal components. Thus, four beamlets (1s, 1p, 2s, 2p) exit beamsplitters 32a and 32b. As depicted, the p-polarized components from the first input fiber and the second input fiber (1p, 2p) pass through a half-wave plate 34 such that all four beamlets (1s, 1s, 2s, 2s) have the same polarization state and are directed at a grating 38. Grating 38 demultiplexes the wavelengths being carried by the four beamlets to create wavelength diversity. Each wavelength carried by the beamlets is a separate communications channel carrying its own information payload. For each wavelength channel defined for the first input fiber, there is a corresponding wavelength channel in the second input fiber. The corresponding wavelength channels in the first and second input fibers are occupied by substantially the same set of wavelengths. However, the information payload carried by the corresponding wavelength channels is different. By switching corresponding wavelength channels between the first and second fiber, their respective information payloads are also switched between the first and second fibers.

The two polarized beamlets derived from the second fiber signal (2s, 2s) then pass through half-wave plate 40 creating polarization diversity. Thus, the first fiber wavelength channels, which do not pass through half-wave plate 40, remain s-polarized (1s, 1s) whereas the second fiber wavelength channels are p-polarized (2p, 2p).

An optical compensator 42 is provided to equalize the optical distances of the first fiber wavelength channels in the second fiber wavelength channels. Optical compensator 42 also reduces dispersion created by grating 38. The dispersion of the wavelength channels created by the grating is smaller within optical compensator 42 as compared with the dispersion in air. Thus, two sets of s-polarized wavelength channels that propagate through optical compensator 42 travel a longer physical distance from grating 38 to beam combiner 44 than do the two sets of p-polarized wavelength channels that do not propagate through optical compensator 42. However, the two sets of s-polarized wavelength channels experience substantially the same total dispersion as experienced by the two sets of p-polarized wavelength channels. A beam combiner 44 is provided to create two identical sets of superimposed wavelength channels (1s, 2p) incident on a focusing lens 46. By superimposing each of the s-polarized wavelength channels with its corresponding p-polarized wavelength channel, each superimposed wavelength channel includes the information payload from the first fiber wavelength channel (is) and the second fiber wavelength channel (2p).

Lens 46 focuses each superimposed wavelength channel onto a corresponding cell within a liquid crystal switch 20 to thereby combine the two identical sets of information into one superimposed wavelength channel incident on the corresponding cell of the liquid crystal switch 20.

In a high-voltage state, the polarization state of a superimposed wavelength channel at the output of a cell of liquid crystal switch 20 is unchanged relative to the polarization state of the same superimposed wavelength channel at the input of the same cell. In the off-voltage state, the liquid crystal switch cell converts (1s, 2p) into (1p, 2s) whereby the polarization state of a superimposed wavelength channel at the output of the liquid crystal switch cell is rotated 90° relative to the polarization state of the same superimposed wavelength channel at the input of the liquid crystal switch cell.

The output birefringent optical system 50 is exactly symmetrical to the previously described input birefringent optical system 30. Thus, the output birefringent optical system includes a polarization beam separator 64 that is similar in construction to polarization beam combiner 44; an optical compensator 62 and a half-wave plate 60 that are similar to optical compensator 42 and half-wave plate 40, respectively; a grating 48 similar to grating 38, and half-wave plate 54 similar to half-wave plate 34; and polarization combiners 52a and 52b that are similar to polarization separators 32a and 32b. With this setup, when a cell of liquid crystal switch 20 is in a high-voltage state, channel (is, 1p) is included in the first fiber output and channel (2s, 2p) is included in the second fiber output. When the cell is in a low-voltage state, channel (2s, 2p) is inserted into the first fiber output and channel (1s, 1p) is inserted into the second fiber output. Thus, in this switched state, information carried by a wavelength channel in the first fiber is switched into the second fiber output and information carried by the corresponding wavelength channel in the second fiber is switched to the first fiber. Because there is one cell in liquid crystal switch 20 per wavelength channel, switching may be performed on a channel-by-channel basis.

The WSS described above is very effective in reducing PDL, while also increasing the extinction ratio and minimizing cross-talk. Nevertheless, the WSS described above utilizes a relatively large number of components, which add to the complexity and expense of the WSS.

### SUMMARY OF THE INVENTION

According to a first embodiment of the present invention, an optical system comprises: a beam polarization combiner for receiving a first set of input beams and a second set of input beams, each beam in the first set of beams having a different wavelength and each beam in the second set of beams having a different wavelength and corresponding to a beam in the first set of beams; and a reflective spatial light modulator having a plurality of individually activated modulating elements each corresponding to a respective one of the different wavelengths of the input beams. Each input beam is directed at a modulating element of corresponding wavelength with input beams of the first set impinging upon the corresponding modulating element from a first incoming path and input beams of the second set impinging upon the corresponding modulating element from a second incoming path. Each modulating element selectively changes the polarization of, and reflects, the input beams such that a first outgoing path for each reflected beam of the first set is superimposed on the second incoming path and a second outgoing path for each reflected beam of the second set is superimposed on the first incoming path. The polarization beam combiner receives the reflected first and second sets of beams and directs the beams in different directions based upon the polarization of the beams as selectively imparted by the reflective spatial light modulator.

According to another embodiment of the present invention, a dynamic spectral equalizer comprises: a polarization beam separator for separating an input beam into first and second orthogonally polarized beamlets that are spatially separated from one another; a dispersive element for dispersing the beamlets into a plurality of beamlet pairs, each beamlet pair corresponding to different wavelengths; and a reflective spatial light modulator having a plurality of individually activated modulating elements each corresponding to a respective one of the beamlet pairs. Each beamlet pair is directed at a corresponding modulating element with the two beamlets forming the pair respectively impinging upon the corresponding modulating element from two separate incoming paths. Each modulating element selectively attenuates and reflects the beamlets such that an outgoing path for each polarized beamlet is superimposed on the incoming path for the other polarized beamlet of the beamlet pair.

According to another embodiment of the present invention, a dynamic spectral equalizer comprises: a first polarization beam separator for separating a first input beam into first and second orthogonally polarized beamlets that are spatially separated from one another; a first polarization changer for changing the polarization of the first beamlet such that the first and second beamlets both have a first polarization; a first dispersive element for separating each of the first and second beamlets into respective first and second sets of component beamlets corresponding to different wavelengths, each component beamlet in the first set having a corresponding component beamlet in the second set at the same wavelength; a second polarization beam separator for separating a second input beam into third and fourth orthogonally polarized beamlets that are spatially separated from one another; a second polarization changer for changing the polarization of one or both of the third and fourth beamlets such that the third and fourth beamlets both have a second polarization opposite the first polarization; a second dispersive element for separating each of the third and fourth beamlets into respective third and fourth sets of component beamlets corresponding to different wavelengths, each component beamlet in the third set having a corresponding component beamlet in the fourth set at the same wavelength; a polarization beam combiner for combining the first and third sets of component beamlets and the second and fourth sets of component beamlets; and a reflective spatial light modulator having a plurality of individually activated modulating elements each corresponding to a respective one of the different wavelengths of the component beamlet. Each composite beamlet is directed at a modulating element of corresponding wavelength with component beamlets of the first and third set impinging upon the corresponding modulating element from a first incoming path and component beamlets of the second and fourth set impinging upon the corresponding modulating element from a second incoming path. Each modulating element selectively attenuates and reflects the incident component beamlets such that a first outgoing path for each reflected component beamlet of the first and third sets are superimposed on the second incoming path and a second outgoing path for each reflected component beamlet of the second and fourth sets are superimposed on the first incoming path.

According to another embodiment of the present invention, a wavelength selective switch comprises: a first polarization beam separator for separating a first input composite beam into first and second orthogonally polarized composite beamlets that are spatially separated from one another; a first polarization changer for changing the polarization of the first composite beamlet such that the first and second composite beamlets both have a first polarization; a first dispersive element for separating each of the first and second composite beamlets into respective first and second sets of component beamlets corresponding to different wavelengths, each component beamlet in the first set having a corresponding component beamlet in the second set at the same wavelength and each such pair of component beamlets constituting a channel signal pair; a second polarization beam separator for separating a second input composite beam into third and fourth orthogonally polarized composite beamlets that are spatially separated from one another; a second polarization changer for changing the polarization of one or both of the third and fourth composite beamlets such that the third and fourth composite beamlets both have a second polarization opposite the first polarization; a second dispersive element for separating each of the third and fourth composite beamlets into respective third and fourth sets of component beamlets corresponding to different wavelengths, each component beamlet in the third set having a corresponding component beamlet in the fourth set at the same wavelength and each such pair of component beamlets constituting a channel signal pair; a polarization beam combiner for combining the first and third sets of component beamlets and the second and fourth sets of component beamlets; and a reflective spatial light modulator having a plurality of individually activated modulating elements each corresponding to a respective one of the different wavelengths of the component beamlets and thereby each corresponding to a channel signal pair from the first input composite signal and a channel signal pair from the second input composite signal. Each composite beamlet is directed at a modulating element of corresponding wavelength with component beamlets of the first and third set impinging upon the corresponding modulating element from a first incoming path and component beamlets of the second and fourth set impinging upon the corresponding modulating element from a second incoming path. Each modulating element selectively changes the polarization of the incident component beamlets such that the two impinging channel signal pairs have different polarizations. The reflective spatial light modulator also reflects the incident component beamlets such that a first outgoing path for each reflected component beamlet of the first and third sets are superimposed on the second incoming path and a second outgoing path for each reflected component beamlet of the second and fourth sets are superimposed on the first incoming path.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

In the drawings:

FIG. 1 is a diagram of a conventional wavelength selective switch;

FIG. 2 is a diagram of an optical system constructed in accordance with a first embodiment of the present invention;

FIG. 3 is a side view of a portion of the optical system shown in FIG. 2;

FIG. 4 is a diagram of an optical system constructed in accordance with a second embodiment of the present invention;

FIG. 5 is a diagram of an optical system constructed in accordance with a third embodiment of the present invention;

FIG. 6 is a diagram of an optical system constructed in accordance with a fourth embodiment of the present invention;

FIG. 7 is a front elevational view of a reflective liquid crystal device that may be utilized in the optical system of the present invention;

FIG. 8 is a cross-sectional view of the reflective liquid crystal device shown in FIG. 7 taken along line VIII-VIII;

FIGS. 9A through 9C are diagrams illustrating the orientation of the liquid crystal molecules within a first version of the liquid crystal device shown in FIGS. 7 and 8;

FIG. 10 is a perspective diagram illustrating the polarization states of an incident and reflected light beam according to a first implementation of the first and third versions of the liquid crystal device shown in FIGS. 7 and 8;

FIG. 11 is a graph of attenuation versus applied voltage for two different implementations of the first version of the liquid crystal device shown in FIGS. 7 and 8;

FIG. 12 is a perspective diagram illustrating the polarization states of an incident and reflected light beam according to a second implementation of the various versions of the liquid crystal device shown in FIGS. 7 and 8;

FIG. 13 is a graph of attenuation versus applied voltage for two different implementations of the first version of the liquid crystal device shown in FIGS. 7 and 8;

FIGS. 14A through 14C are diagrams illustrating the orientation of the liquid crystal molecules within a second version of the liquid crystal device shown in FIGS. 7 and 8;

FIG. 15 is a perspective diagram illustrating the polarization states of an incident and reflected light beam according to a first implementation of the second version of the liquid crystal device shown in FIGS. 7 and 8;

FIG. 16 is a graph of attenuation versus applied voltage for two different implementations of the second version of the liquid crystal device shown in FIGS. 7 and 8;

FIG. 17 is a graph of attenuation versus applied voltage for two different implementations of the second version of the liquid crystal device shown in FIGS. 7 and 8;

FIGS. 18A through 18C are diagrams illustrating the orientation of the liquid crystal molecules within a third version of the liquid crystal device shown in FIGS. 7 and 8;

FIG. 19 is a graph of attenuation versus applied voltage for two different implementations of the third version of the liquid crystal device shown in FIGS. 7 and 8; and

FIG. 20 is a graph of attenuation versus applied voltage for two different implementations of the third version of the liquid crystal device shown in FIGS. 7 and 8.

### DETAILED DESCRIPTION OF THE PREFERRED EMBODIMENTS

Various embodiments of an optical system of the present invention are described below that may constitute either a dynamic spectral equalizer (DSE) or a wavelength selective switch (WSS). It will be appreciated, however, that aspects of the inventive optical system may be employed in other optical components having different functions from either a DSE or a WSS. A first embodiment of the optical system is a DSE and is shown in FIG. 2. The depicted optical system 100 shown in FIG. 2 includes a circulator 102 coupled to an input fiber 104, an output fiber 106, and a common fiber 108. Input fiber 104 supplies an input composite light beam to circulator 102, which outputs this input composite beam on common fiber 108 with substantially no leakage to output fiber 106. As will be described further below, light beams propagate in both directions through common fiber 108. Light beams that circulator 102 receives via common fiber 108 are output by circulator 102 on output fiber 106 with substantially no leakage to input fiber 104. A lens 110 is provided at the opposite end of common fiber 108 from circulator 102. Lens 110 collimates the input composite light beam supplied from common fiber 108 while focusing collimated beams it receives from its opposite direction and coupling such beams into common fiber 108 for transmission to circulator 102.

Optical system 100 further includes a polarization beam separator/combiner 112, which separates the input composite light beam into two spatially separated, orthogonally polarized first and second composite beamlets. A polarization changer (i.e., a polarizer or retarder) 114 is provided in the path of one of the first and second orthogonally polarized composite beamlets so as to change the polarization of that composite beamlet to be the same as the other composite beamlet. A dispersive element 116 is provided to spectrally disperse the first composite beamlet into a first set of spatially separated component beamlets and to spectrally disperse the second composite beamlet into a second set of spatially separated component beamlets. Each of the component beamlets of the first set corresponds to different communication channels of the first input composite beam as does each component beamlet of the second set. Each component beamlet in the first set has a corresponding component beamlet in the second set at the same wavelength, which together constitute a “channel pair.”

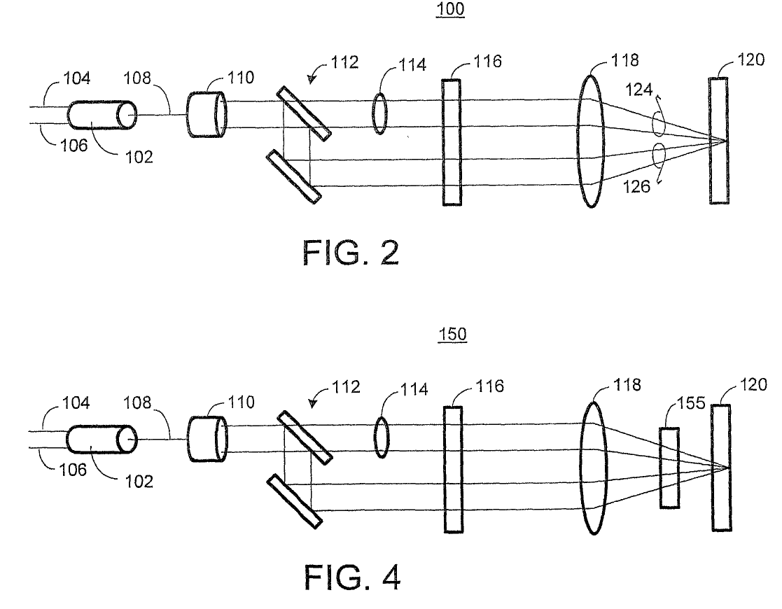

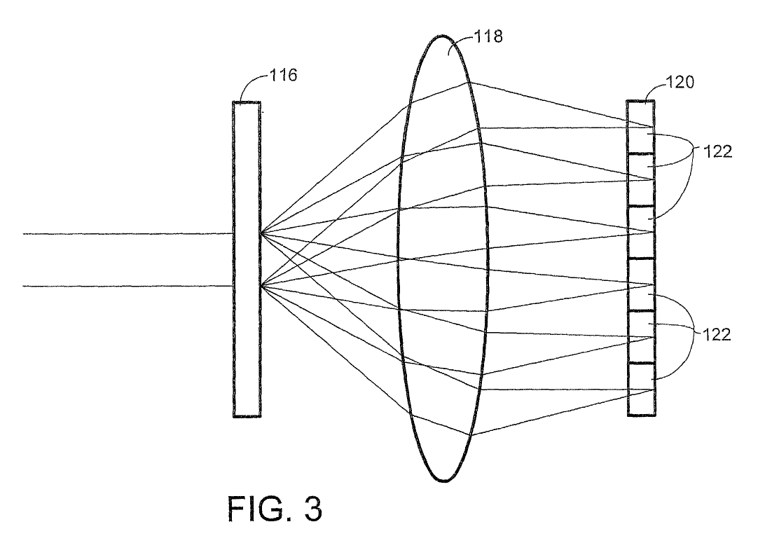

Assuming FIG. 2 is a top plan view of the optical system, FIG. 3 is a side elevational view showing the spatial separation of the component signals by dispersive element 116. It will be appreciated that the polarizations can be separated in the same plane as the dispersion of the dispersive element 116 or in a plane perpendicular to the dispersion of dispersive element 116. For purposes of example, six different component signals are illustrated. It will be appreciated, however, that the number of component signals will be dependent upon the number of channels carried by the input and output fibers. As shown in FIGS. 2 and 3, a lens 118 is provided for focusing each of the component beamlets onto a corresponding modulating element 122 of a reflective spatial light modulator 120. As will be described in further detail below, each modulating element 122 of reflective spatial light modulator 120 may be independently activated so as to selectively modulate each of the beamlets so that its proportional power after collection at the output fiber is at the desired value. Furthermore, the optical system is constructed such that the first set of component beamlets is focused onto a reflective surface of light modulator 120 at an angle equal to and opposite that of the second set of component beamlets. Thus, as shown in FIG. 2, the first set of component beamlets that is directed at reflective spatial light modulator 120 along a first incoming path 124 is reflected to a first outgoing path that is superimposed upon a second incoming path 126 for the second set of component beamlets. Likewise, the second set of component beamlets is reflected by reflective spatial light modulator 120 to a second outgoing path superimposed upon the first incoming path 124. The reflected first and second sets of component beamlets are then collimated by lens 118 and directed back to dispersive element 116, which recombines each set of reflected component beamlets into first and second reflected composite beamlets. Polarization changer 114 then changes the polarization of one of the reflected composite beamlets such that the two reflected composite beamlets are orthogonally polarized with respect to one another. Polarization beam separator/combiner 112 then combines the two reflected composite beamlets and it directs the superimposed beamlets to lens 110, which couples the resultant output composite beam to common fiber 108, which in turn supplies the output composite beam to circulator 102, which outputs the output composite beam on output fiber 106.

Polarization beam separator/combiner 112 may be a pair of beam polarizing beamsplitters. Alternatively, other polarization beam separators may be utilized including, but not limited to, birefringent plates, polarizing prisms, and polarization beamsplitting slabs. The polarization changer 114 may be, but is not limited to, a retardation plate, a crystal rotator, or a liquid crystal. Dispersive element 116 may be, but is not limited to, a grating, prism, or grism. Reflective spatial light modulator 120 may be, but is not limited to, reflective liquid crystal displays, pixellated birefringent crystal arrays, MEMs devices, and arrays of variable filters.

For many applications, it is desirable to have a DSE that can achieve very high extinction blocking (e.g., 35 dB or higher), so that it can block portions of the optical spectrum to a high degree. In practice, limitations on the quality of the components available for the approach illustrated in FIG. 2 may prevent achieving very high extinction when reflective polarization modulators are used as the reflective spatial light modulator 120.

FIG. 4 shows a second embodiment of the present invention, which is a high extinction, extremely low polarization dependent DSE 150. DSE 150 has a nearly identical structure to that shown in FIGS. 2 and 3 with the exception that an additional polarizer 155 has been added between lens 118 and reflective spatial light modulator 120. It should be noted that polarizer 155 can be placed anywhere between polarization changer 114 and reflective spatial light modulator 120. Polarizer 155 serves to increase the polarization purity of the input beam to reflective spatial light modulator 120 and to improve the polarization filtering of the output beam from reflective spatial light modulator 120. Polarizer 155 can be, but is not limited to, a polarizing prism, a polymer linear polarizer, a polarcor linear polarizer, or one or more Brewster plates. Reflective spatial light modulator 120 can be, but is not limited to, a reflective liquid crystal device or a pixellated birefringent crystal array.

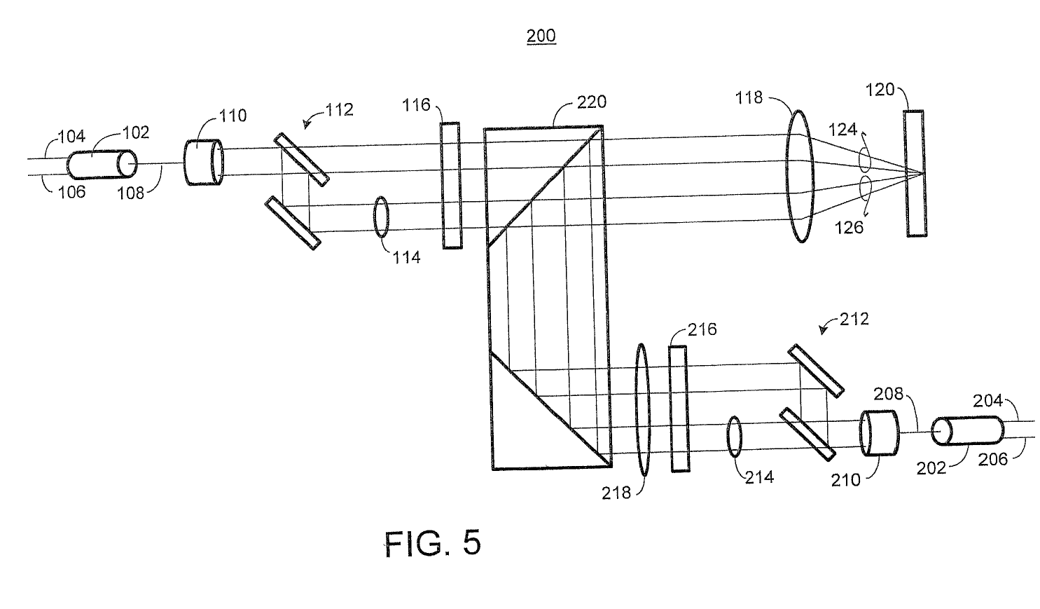

The optical system shown in FIGS. 2 and 3 may be readily converted into a WSS by adding the additional components shown in FIG. 5, which shows an optical system 200 according to a third embodiment of the present invention. Specifically, a second circulator 202 may be added that is coupled to a second input fiber 204, a second output fiber 206, and a second common fiber 208. Similarly, a second lens 210 may be provided between the output of second common fiber 208 and a second polarization beam separator 212. Second circulator 202, second lens 210, and second polarization beam separator 212 may be constructed in an identical fashion to first circulator 102, first lens 110, and first polarization beam separator 112, respectively. Thus, second polarization beam separator 212 separates a second input composite beam received from second input fiber 204 into spatially separated, orthogonally polarized third and fourth composite beamlets.

A second polarization changer 214 is provided in the path of one of the third and fourth composite beamlets so as to change its polarization to be identical to that of the other of these two composite beamlets. A second dispersive element 216 similar to first dispersive element 116 is positioned so as to disperse the third and fourth composite beamlets into respective third and fourth sets of component beamlets.

Unlike the structure shown in FIG. 2, a third polarization changer 218 is provided in the paths of all of the third and fourth sets of component beamlets so as to change the polarization of the beamlets from the second input fiber 204 to have the opposite polarization of those from the first input fiber 104. The oppositely polarized component beamlets from the first and second input fibers are then combined by a polarization beam combiner 220 such that the first set of component beamlets is superimposed with the third set of component beamlets and the second and fourth sets of component beamlets are superimposed upon one another, and then all the beamlet sets are directed at lens 118 in a manner similar to that described above with respect to FIGS. 2 and 3. Lens 118 focuses the sets of beamlets onto a corresponding modulating element 122 of reflective spatial light modulator 120. The first and third sets of component beamlets are directed at their corresponding modulating element 122 along a first incoming path 124 at an angle relative to the reflective surface of reflective spatial light modulator 120 so as to have an outgoing path that is superimposed upon the second incoming path 126 of the second and fourth sets of component beamlets. Likewise, the second and fourth sets of component beamlets have an outgoing path that is superimposed on the incoming path 124 of the first and third sets of component beamlets. The outgoing reflected component beamlets are then collimated by lens 118 and subsequently separated by beam polarization combiner 220.

When the optical system 200 shown in FIG. 5 and described above is configured to operate as a WSS, a first input composite beam entering system 200 on first input fiber 104 passes from the first input fiber to circulator 102, which in turn passes the beam to common fiber 108 without substantial leakage into output fiber 106. The first input composite beam on common fiber 108 is then substantially collimated by lens 110 and is then separated by first polarization beam separator 112 into orthogonally polarized first and second composite beamlets. First polarization changer 114 changes the polarization of the second composite beamlet to be the same as the first composite beamlet. The first and second composite beamlets are then incident on dispersive element 116, which outputs first and second sets of component beamlets whose propagation direction is dependent on their wavelength. These first and second component beamlets pass through polarization beam combiner 220 and are focussed by lens 118 such that they are separated spatially at reflective spatial light modulator 120 and such that their focus is substantially coincidental with the reflective surface of reflective spatial light modulator 120. As noted above, the system is configured such that the first set of component beamlets is directed at reflective spatial light modulator 120 along a first incoming path 124 such that they exit reflective spatial light modulator 120 along a first outgoing path that is superimposed along the second incoming path 126 of the second set of component beamlets. Likewise, the second set of component beamlets exit reflective spatial light modulator along a second outgoing path that is superimposed on the first incoming path 124 of the first set of component beamlets. The sets of component beamlets pass through the lens 118 again and are redirected toward polarization beam combiner 220.

For a WSS, reflective spatial light modulator 120 is preferably a reflective polarization modulator. Thus, each modulating element 122 may be selectively activated (or deactivated) to rotate the polarization of the corresponding incident component beamlets. When deactivated (or activated), the polarization state of the incident beamlets remains the same. Because there is one modulating element 122 provided for each channel (i.e., wavelength), and hence for each pair of component beamlets from the first and second sets, each channel may be selectively and independently affected by rejective spatial light modulator 120.

For those component beamlets originating from first input fiber 104 that leave reflective spatial light modulator 120 with the same polarization, the beamlets pass through polarization beam combiner 220 toward first dispersing element 116 and ultimately toward first output fiber 106. However, for those component beamlets whose polarization was rotated by a modulating element 122 of reflective spatial light modulator 120, polarization beam combiner 220 redirects those component beamlets toward third polarization changer 218, dispersive element 216, and ultimately to second output fiber 206. Each dispersive element 116 and 216 recombines the two incident sets of component beamlets into two composite beamlets. The first and second polarization changers then rotate the polarization of one of the two component beamlets so that they are orthogonally polarized and the first and second polarization beam separators 112 and 212 combine the two orthogonally polarized beamlets to form a single output composite beam. The lenses 110 and 210 then focus the output composite beam so as to couple the beam into common fibers 108 and 208. The circulators 102 and 202 then direct the output composite beam toward the first output fiber or the second output fiber, respectively, without substantial leakage to the input fibers.

As will be apparent to those skilled in the art, a second input composite beam on second input fiber 204 passes through the elements described above and is separated into third and fourth sets of component beamlets prior to being redirected by beam polarization combiner 220. For a WSS, the first and third sets of component beamlets are superimposed upon one another exactly when incident upon reflective spatial light modulator 120. Likewise, the second and fourth sets of component beamlets are superimposed. Thus, for a given wavelength channel, when the corresponding modulating element 122 does not rotate the polarization of the incident beamlets, the beamlet originating from first input fiber 104 exits the optical system on first output fiber 106 and the beamlet originating from second input fiber 204 exits second output fiber 206. However, when the corresponding modulating element 122 rotates the polarization of the incident beamlets, the beamlet originating from first input fiber 104 exits the optical system on second output fiber 206 and the beamlet at the corresponding wavelength that originates on second input fiber 204 exits the system on first output fiber 106. Thus, each channel carried on the input fibers may be independently switched.

The optical system 200 may be modified in a number of different ways so as to perform the function of a dual DSE. In such a dual DSE, the reflective spatial light modulator could still be a reflective polarization modulator, however, it may be tuned to an intermediate value or may be replaced by a spatial light modulator that combines polarization modulation capabilities with some other capability including, but not limited to, variable attenuation, variable misalignment, and variable wavefront error. In such a system, the input beams on first input fiber 104 would always exit first output fiber 106 unless they were effectively extinguished by reflective spatial light modulator 120. Similarly, second input beams on second input fiber 204 would always be output on second output fiber 206 unless effectively extinguished.

Another way to create a dual DSE using optical system 200 shown in FIG. 5 would be to align lenses 110 and 210 such that the beams that originated from input fibers 104 and 204 are not substantially superimposed at reflective spatial light modulator 120. This allows the two inputs to be modulated independently and reduces to near zero the effect of discarded power from the attenuation of one input on the signal to noise ratio of the signal from the other input. For such a dual DSE, the reflective spatial light modulator can be any reflective spatial light modulator that enables variable attenuation, variable misalignment, variable introduction of wavefront error, polarization modulation, or any other effect that will allow the intensity of the light that reaches the output fibers to be attenuated. Examples of such reflective spatial light modulators include, but are not limited to, reflective liquid crystal devices, pixellated birefringent crystal arrays, MEMs devices, and arrays of variable filters.

Polarization beam combiner 220 may be a polarizing beam-combining prism such as that depicted in FIG. 5. For ease of presentation, the depicted polarizing beam-combining prism has been illustrated as producing a spatial offset and a 180° direction change for incoming beamlets that originated from second input fiber 204. In practice, any polarization beam combiner that produces a spatial or angular offset that is sufficient to allow the incoming beams from the first and second input fibers to be superimposed onto each other can be used for this purpose. Such polarization beam combiners include, but are not limited to, birefringent plates, polarizing prisms, and polarization beamsplitting slabs. For some polarization modulators, it may be desirable that the incoming beamlets all share substantially the same sets of orthogonal polarizations. In these cases, it may be advantageous that the surface normal of the polarizing surface of the polarization beam-combining prism be substantially parallel to the plane of dispersion of the dispersive elements.

When reflective spatial light modulators are utilized that have an interface between a birefringent material and a non-birefringent material at or near the reflection plane, this interface causes a back reflection that has a component that is orthogonal to the back reflections from all interfaces between non-birefringent materials. Extinction may often be limited by this orthogonal component.

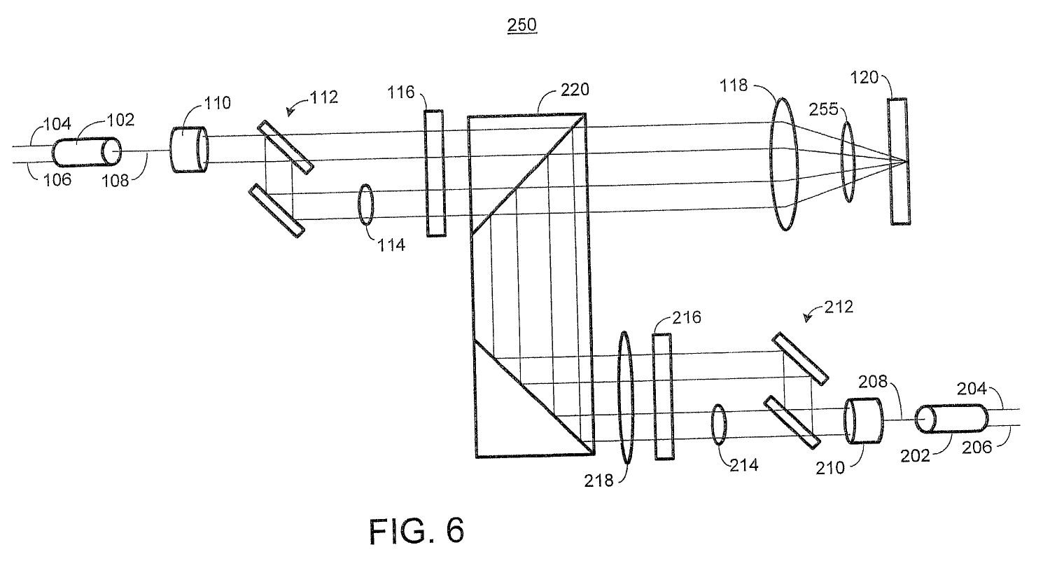

FIG. 6 shows a fourth embodiment of the present invention, which is a high extinction, extremely low polarization dependent WSS or dual DSE 250 with an additional retarder 255 disposed between lens 118 and reflective spatial light modulator 120. When the value of additional retarder 255 between lens 118 and reflective spatial light modulator 120 is nearly, but not exactly, one-quarter wave for the wavelengths used in the device, the voltage of the reflective spatial light modulator (particularly when implemented with a liquid crystal device) can be tuned in such a way that the component of the back reflection off of the birefringent interfaces that is orthogonal to all other back reflections can be substantially eliminated. Additionally, because retarder 255 is nearly one-quarter wave, all other back reflections for the output that return to the fiber from which it was received are substantially eliminated by the retarder 255. In practice, this method of compensation enables isolation of substantially greater than 40 dB to be consistently achieved. It should be noted that additional retarder 255 can also be disposed between lens 118 and polarization beam combiner 220 to achieve the same result. It is also noted that additional retarder 255 can be used in the single DSE embodiment shown in FIG. 4 to improve its isolation to substantially greater than 40 dB.

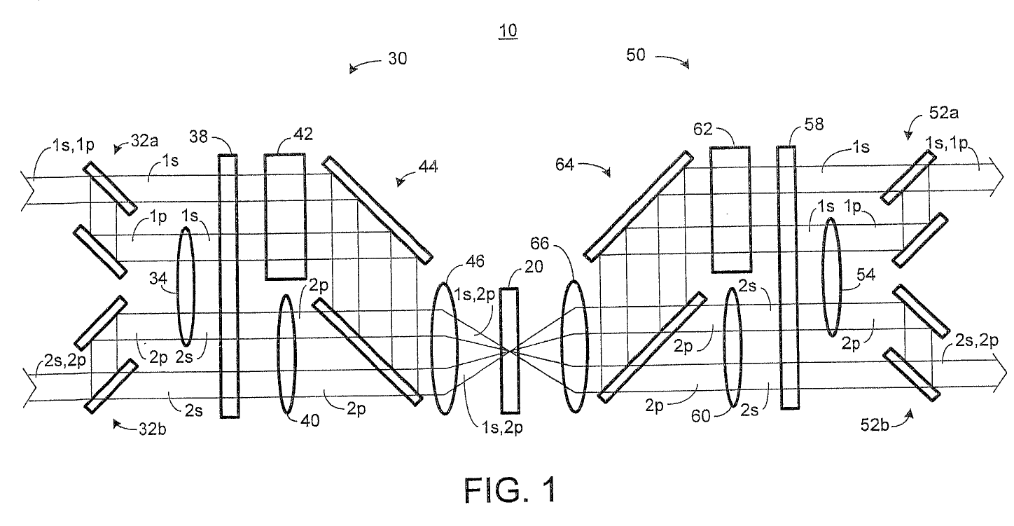

Upon comparison of the transmissive WSS shown in FIG. 1 with the reflective WSS shown in either FIG. 5 or 6, it will be apparent that the component count and complexity of the system is significantly reduced by utilizing a reflective geometry. A significant characteristic of the optical system of the present invention is that the input beam is split into two polarization components that travel the identical optical paths but in opposite directions. Because optical effects that cause loss, phase shift, and time delay typically are not dependent on propagation direction, this ensures that PDL and PMD are extremely low.

As noted above, reflective spatial light modulators may have various constructions without departing from the spirit and scope of the present invention. Described below are three different versions of reflective spatial light modulators constructed using liquid crystal (LC) devices. The LC implementations of reflective spatial light modulator 120 that are described below are also described in commonly assigned U.S. Provisional Patent Application No. 60/283,756 filed on Apr. 13, 2001, and in commonly assigned U.S. Patent Application No. ______ [Attorney Docket No. COR20 P413] entitled “HIGH CONTRAST REFLECTIVE LCD FOR TELECOMMUNICATIONS APPLICATIONS” filed on even date herewith. The entire disclosures of each of these applications are incorporated herein by reference.

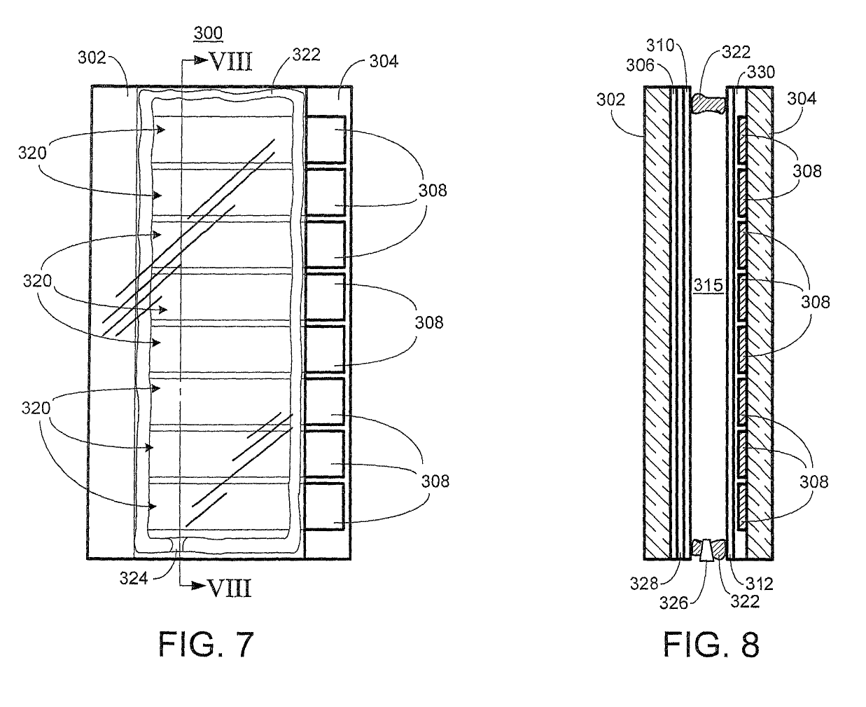

FIGS. 7 and 8 show the general structure of the preferred reflective LC device 300. As will be explained further below, the same general physical structure is utilized for each of the three versions thereof.

As illustrated in FIG. 7, reflective LC device 300 includes a transparent first substrate 302 having a first surface upon which at least one light beam is incident, and a second surface opposite the first surface. LC device 300 further includes a second substrate having first and second surfaces where the first surface of second substrate 304 is opposed to the second surface of first substrate 302. A transparent first electrode layer 306 (see FIG. 8) is supported on the second surface of first substrate 302. As used herein, the phrase “supported on” shall refer not only to situations where a supported layer is disposed directly on a supporting surface, but also where there are intermediate layers between the supported layer and the supporting surface/structure. A second electrode layer 308 is supported on the first surface of second substrate 304. The first alignment layer 310 is supported on the second surface of first substrate 302 while a second alignment layer 312 is supported on the first surface of second substrate 304. An LC medium 315 is disposed between first electrode layer 306 and second electrode layer 308. At least one of electrode layers 306 and 308 is patterned so as to define a plurality of independently activated liquid crystal elements 320, each sized to receive one of the input light beams. Second electrode layer 308 may be made of a reflective material or may be made of a transparent material depending upon whether second substrate 304 is otherwise already reflective or if second substrate 304 carries a reflective layer on one of its surfaces.

Liquid crystal elements 320 are preferably independently operable to change between half-wave and zero retardation states in response to an applied voltage. The manner in which this is accomplished is described further below with respect to the various versions. Second substrate 304 need not be transparent so long as electrodes 308 are reflective or so long as a reflective coating is otherwise provided on the first surface of second substrate 304. If substrate 304 is transparent and electrodes 308 are transparent, a reflective coating may be applied to the rear second surface of substrate 304. It should also be noted that electrodes 308 may be made of a single material, or may be made of a series of sublayers of different materials so as to enhance the adhesion of the electrode material to the second substrate or to the other layers of the device.

Referring to FIGS. 7 and 8, first substrate 302 is spaced apart from second substrate 304 and a seal 322 is provided about the periphery of the overlapping portions of substrates 302 and 304 to define a sealed chamber therebetween. Spacers (not shown) may be placed in seal 122 or elsewhere between substrates 302 and 304 to maintain uniform spacing. A small aperture 324 is provided in seal 122 so as to fill the chamber with the LC medium 315 using known vacuum-filling techniques. A UV-curable plug 326 may then be inserted into the hole to prevent leakage of the LC medium from the LC device.

As shown in FIG. 7, first substrate 302 may be laterally shifted with respect to second substrate 304 so as to expose the electrodes 306 and 308 for electrical coupling to a device driver circuit (not shown). This driver circuit would independently apply a voltage to the patterned electrodes and hence across each of the LC elements 320. As noted above, either electrode 306 or 308 may be patterned or alternatively both electrodes may be patterned. It will further be appreciated that each of the LC elements 320 may be independently sealed, if desired. In general, however, such independent sealing may not be required and may unduly complicate the manufacture of the device.

In each of the versions described below, the LC device may further include a first protection layer 328 disposed between first electrode 306 and LC medium 315. A similar second protection layer 330 may likewise be applied between electrodes 308 and LC medium 315. The protection layers serve to prevent the flow of electrons through LC medium 315.

The LC device described above and shown in FIGS. 7 and 8 may be made using the following procedure. First, an electrically conductive layer is deposited on each of the two substrates 302 and 304. The conductive layer applied to substrate 302 should be transmissive so as to provide a transparent electrically conductive electrode 306. Transparent electrically conductive layer 306 may be indium tin oxide (ITO) or any other suitable material. It should be noted that glass substrates coated with ITO are commercially available. The conductive layer applied to second substrate 304 is preferably reflective. Suitable materials include metals such as gold, white gold, silver, platinum, chromium, and alloys thereof.

Once the conductive layers are applied to substrates 302 and 304, one of the conductive layers may be patterned or alternatively both may be patterned to provide for a multi-pixel LC device. Both dry and wet etching techniques can be utilized.

After the electrodes 306 and 308 have been applied and patterned where necessary, protection layers 328 and 330 may be applied over electrodes 306 and 308, respectively. The protection layers prevent the electrons from the electrodes from getting into the LC medium 315 and also help the adhesion of the alignment chemical of alignment layers 310 and 312 to the electrodes. Suitable materials for protection layers 328 and 330 include alumina (Al₂O₃) and silica (SiO₂).

Subsequently, alignment layers 310 and 312 are deposited on protection layers 328 and 330, respectively. As noted below, the alignment layers may be either homeotropic or homogenous. For homogenous alignment layers, polyimide is a typical material to be deposited. For homeotropic alignment layers, copolymers, such as polymaleic anhydride-alt-1-octadecene, and certain kinds of polyimide (such as SE-1211), may be used. After the alignment layers are deposited, they are typically rubbed in order to provide the LC molecules with an orientational preference. For each of the versions described below, the two alignment layers 310 and 312 are rubbed in opposite directions at a 45 degree angle relative to the polarization of the incident and exiting light beams.

The next step is to dispense a mixture of glue and spacers on one of the substrates to form seal 122. The spacers may be spread out across the entire surface of the substrate to which the glue and spacer mixture is applied. These spacers may either be optically transparent or may be made of a material that will dissolve in the LC medium. The other substrate is then placed on top of the other substrate and the glue mixture is cured with a pressure applied on the sample to ensure the gap is the same size as the spacers. As noted above, an opening may be left in the glue pattern/seal 122 to allow dispersal of the LC medium within the otherwise sealed chamber. The LC medium can be vacuum-filled into the gap between the substrates. After the LC medium is filled, the opening can be plugged by glue or some other form of plug.

The LC devices are preferably configured to have a relatively small viewing angle (approximately 4 degrees) and extremely high contrast ratio (greater than 10,000:1). LC devices exhibiting the small viewing angles and high contrast ratios are disclosed in commonly assigned U.S. patent application Ser. No. 09/429,135 and U.S. Provisional Patent Application No. 60/129,798, the disclosures of which are incorporated herein by reference. The LC devices disclosed in these applications are all transmissive. An additional desirable specification for the LC device of the present invention is for polarization dependent loss (PDL) to be less than 0.2 dB over all attenuation and switching configurations. This is attainable by utilizing a reflective-based geometry for the product design. As noted above, this may be achieved by utilizing reflective electrodes or other layers or substrates in the LC device.

With respect to contrast ratio, the limiting factor is reflections off the numerous index-bearing interfaces in the LC device. These reflections can be diminished by using anti-reflection (AR) coatings. However, in practice, some reflection will always exit and limit performance. However, if each undesired reflection had the identical polarization, the performance could be significantly improved using isolation techniques. A significant attribute in the cell designs discussed below is that the alignment layer is chosen such that a coating can be designed to minimize reflection and that the polarization of the reflection does not change. The inventors have discovered that the reflection off an isotropic layer (such as an AR coating) and a birefringent material (homogenous aligned LC) is a limiting factor. These reflections typically alter the polarization and limit performance. The LC device can appear to be isotropic with a homeotropic alignment layer. As described further below, each LC device of the three versions has two alignment layers. The LC device according to the first version (hereinafter referred to as “electrically controlled birefringence (ECB)”) uses homogenous alignment for both. The LC device of the second version (hereinafter referred to as “vertically aligned nematics (VAN)”) uses homeotropic alignment for both alignment layers. The LC device of the third version (hereinafter referred to as “hybrid aligned nematic (HAN)”) uses one homeotropic and one homogenous alignment layer. As will be apparent to those skilled in the art, the VAN LC device would have the best contrast ratio followed by the HAN and finally the ECB LC device.

Another important attribute of an LC device is channel uniformity. Specifically, it is important that the LC device has uniform optical performance across at least the portion of each LC element 320 through which light is passed. This implies that the fringing field effect from neighboring LC elements 320 should be minimized. The ECB and HAN LC devices have excellent uniformity while the VAN LC device exhibits some uniformity degradation.

Overall, the HAN LC device provides the most desirable properties for the reflective cell geometry for the telecommunications application that is described below, since it is the best compromise of the various cell performance factors. However, each version has its unique properties that may be advantageous for differing applications.

The chemical structure of liquid crystals is asymmetric and, as a result, their dielectric and optical properties are asymmetric as well. LC molecules exhibit birefringence and can be aligned by external fields. For example, when an electric field is applied to an LC medium with positive dielectric anisotropy, the LC molecules tend to align with the field, which results in rotation (or tilt) of the LC molecules. On the other hand, when an LC medium with a negative dielectric anisotropy is utilized and when an electric field is applied, the LC molecules tend to align perpendicularly to the field, which results in rotation (or tilt) of the LC molecules. LC devices can thus be used to make switchable wave-plates or wave-guides. The output intensity of light depends on the configuration and refractive indices of the components of the LC devices.

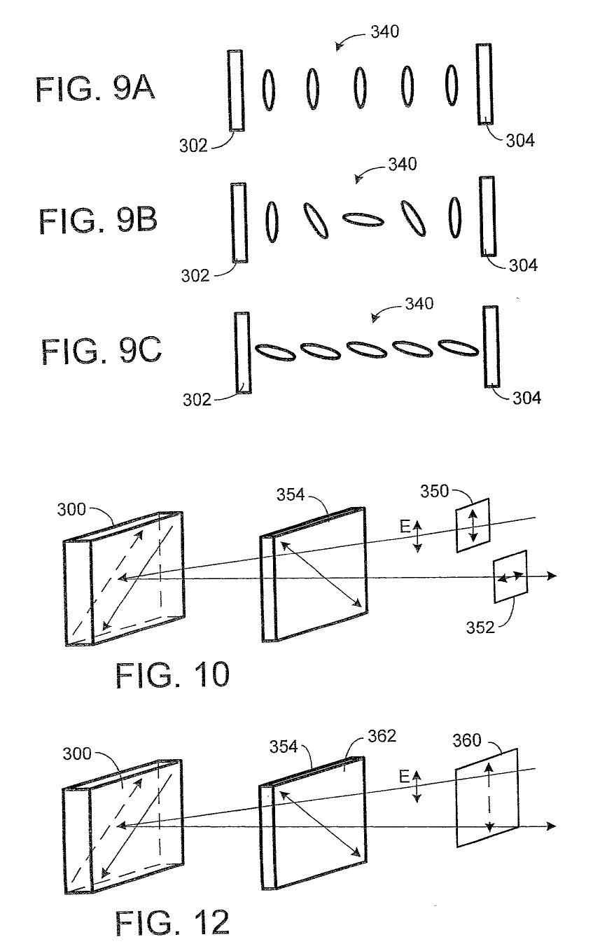

As stated above, the LC device of the first version is an ECB LC device. Such an ECB LC device utilizes an LC medium 315 with a positive dielectric anisotropy and the alignment layers 310 and 312 are both homogenous. As shown in FIG. 9A, when no voltage is applied to electrodes 306 and 308, the LC molecules 340 are more or less parallel to the surfaces of the two substrates 302 and 304. With the right thickness, the LC device 300 of the first version functions as a half-wave plate, which can rotate the incident polarization by 90 degrees when the LC molecular orientation in the substrate plane is 45 degrees with respect to the incident polarization. With an intermediate voltage applied, the LC molecules 340 in the middle begin to rotate, as shown in FIG. 9B. When a high voltage is applied, all the LC molecules 340, except at the surfaces, will align with the field and the LC device has basically zero retardation, as shown in FIG. 9C. Thus, when a high voltage is applied, the incident light will retain its initial polarization.

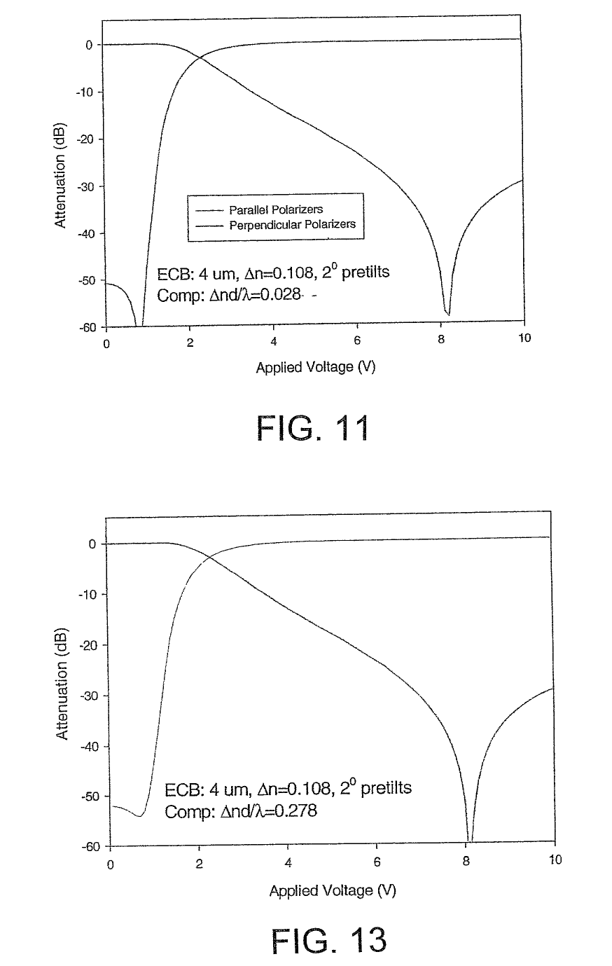

Alignment layers 310 and 312 are preferably deposited over the protection layers 328 and 330. For the ECB LC device of the third version, the LC molecules 340 are preferably aligned parallel to the substrate surfaces when no voltage is applied. Polyimide is a typical choice for homogenous (parallel to the surface) alignment layers. When polyimide is used for homogenous alignment, it is preferably rubbed in order to give the LC molecules an orientation preference. One configuration of a reflective ECB LC device as an optical switch is shown in FIG. 10. As illustrated, reflective ECB LC device 300 has its homogenous alignment layers rubbed in opposite directions at a 45 degree angle relative to the polarization of the incident and exiting light beams. As illustrated in FIG. 10, two polarizers 350 and 352 are utilized. Polarizers 350 and 352 can have polarizations that are either parallel or perpendicular to each other. A birefringence medium 354 may be placed in front of LC device 300 to compensate for the residual birefringence when a high voltage is applied. As noted above, the reflective ECB LC device 300 is a half-wave retarder when no voltage is applied. The results of a simulation of the device used in the configuration shown in FIG. 10 is shown in FIG. 11 in cases where the polarizers 350 and 352 have their polarizations perpendicular and where they are parallel. As apparent from the graph shown in FIG. 11, attenuation of greater than 40 dB may be attained in one voltage state whereas virtually zero attenuation is attained in the other voltage state.

FIG. 12 shows an alternative configuration whereby instead of using two polarizers 350 and 352, a single polarizer 360 combined with a quarter-wave plate 362 is utilized. Quarter-wave plate 362 can further be combined and integrated with the compensation medium 354. The results of a simulation using this structure are illustrated in FIG. 13.

As shown in FIGS. 10 and 12, the slow axis of the compensating medium 354 is preferably 45 degrees relative to the polarization of the incident and reflected light and is perpendicular to the rub direction of the alignment layers of LC device 300.

As noted above, the LC device of the second version is a VAN LC device including an LC medium 315 having a negative dielectric anisotropy, and including alignment layers 310 and 312 that are both homeotropic. The function of the homeotropic alignment layer is to give the LC molecules a preference of orientation that is close to perpendicular to the substrates. Examples of alignment chemicals, which give homeotropic alignment (perpendicular to a substrate) are copolymers, such as polymaleic anhydride-alt-loctadecene, and certain kinds of polyimide (SE-1211). For a VAN LC device, in order to give the LC molecules 340 an orientational preference when a voltage is applied, at least one of the alignment layers should provide an alignment direction different from 90 degrees. One way to achieve this is to rub the polyimide. The polyimide may be rubbed in the same manner as disclosed with respect to the first version.

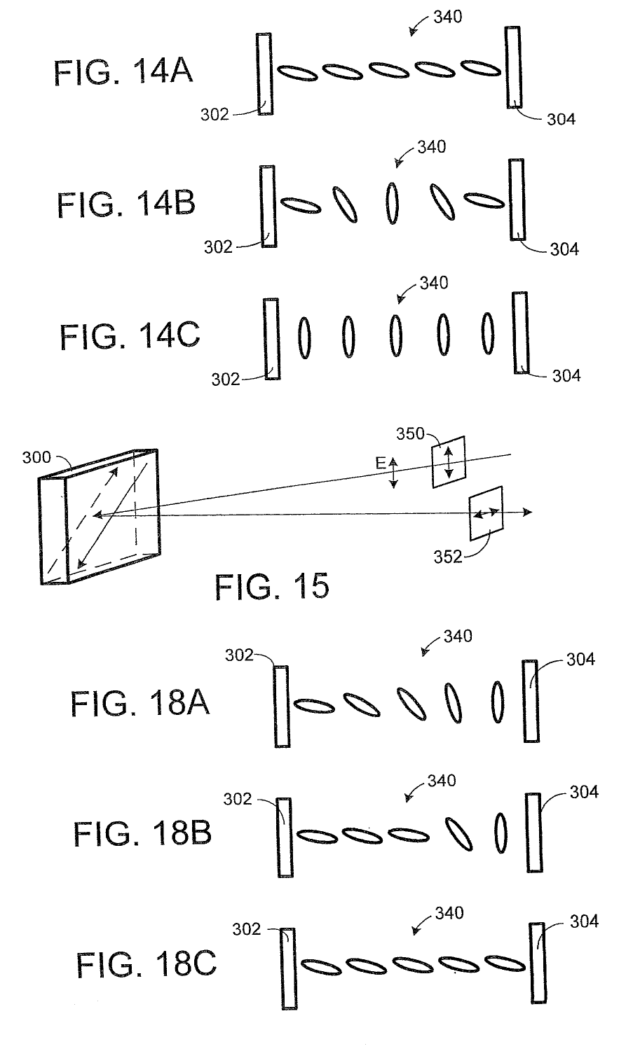

In the VAN LC device 300, when no voltage is applied, all the LC molecules 340 are aligned in one direction and close to perpendicular to substrates 302 and 304, as shown in FIG. 14A. The retardation of the system is close to zero when no voltage is applied and hence the polarization of the incident light will be maintained. When an intermediate voltage is applied, the LC molecules 340 in the middle of the LC medium 315 begin to rotate, as shown in FIG. 14B. When a high voltage is applied, all the LC molecules 340, except at the surfaces, will align perpendicular to the field as shown in FIG. 14C. With the right thickness, LC device 300 can function as a half-wave plate, which can rotate the incident polarization by 90 degrees when the LC molecules are aligned 45 degrees with respect to the incident polarization.

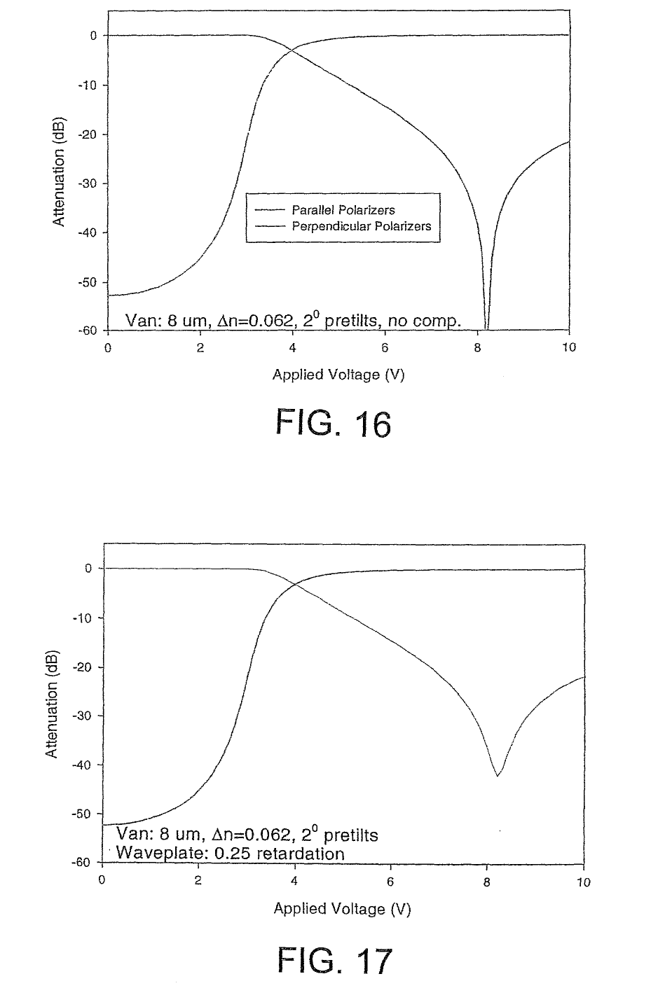

The configuration of the VAN LC device 300 as an optical switch is shown in FIG. 15 in which two polarizers 350 and 352 are utilized. Polarizers 350 can have their polarizations either parallel or perpendicular to each other. As noted above, the reflective VAN LC device 300 is a half-wave retarder when a high voltage is applied. The simulation results of the configuration shown in FIG. 15 are shown in FIG. 16.

Instead of using two polarizers 350 and 352, one polarizer 360 and a quarter-wave plate 362 may be utilized. Such a configuration is shown in FIG. 12. It should be noted, however, that for a VAN LC device, it may not be necessary to utilize, or combine the quarter-wave plate with, a compensating birefringence medium 354. The results of a simulation utilizing a structure similar to that shown in FIG. 12 but without a compensating birefringence medium 354 are shown in FIG. 17.

The third version of the present invention is a hybrid ECB LC device (also referred to herein as an “HAN LC device”). In the HAN LC device, a liquid crystal medium 315 is used that has a positive dielectric anisotropy. In this version, one of the alignment layers 310 and 312 is homogenous while the other is homeotropic. In the HAN LC device 300, when no voltage is applied, the LC molecules 340 are perpendicular to the surface at one substrate 302 and parallel to the surface at the other substrate 304. The orientation of the LC molecules 340 exhibits a gradual transition from one surface to the other as shown in FIG. 18A. With the right thickness, the HAN LC device 300 functions as a half-wave plate, which can rotate the incident polarization by 90 degrees when the LC molecular orientation in the substrate plane is 45 degrees with respect to the incident polarization. Such an orientation is attained by rubbing the alignment layers in a direction similar to that shown in FIGS. 10 and 12. With an intermediate voltage applied, the LC molecules 340 in the middle off LC medium 340 begin to rotate as shown in FIG. 18B. When a high voltage is applied, all the LC molecules 340, except at the surfaces, will align with the field and the LC device has basically zero retardation, as shown in FIG. 18C. Thus, when a high voltage is applied, the polarization of the incident light is maintained.

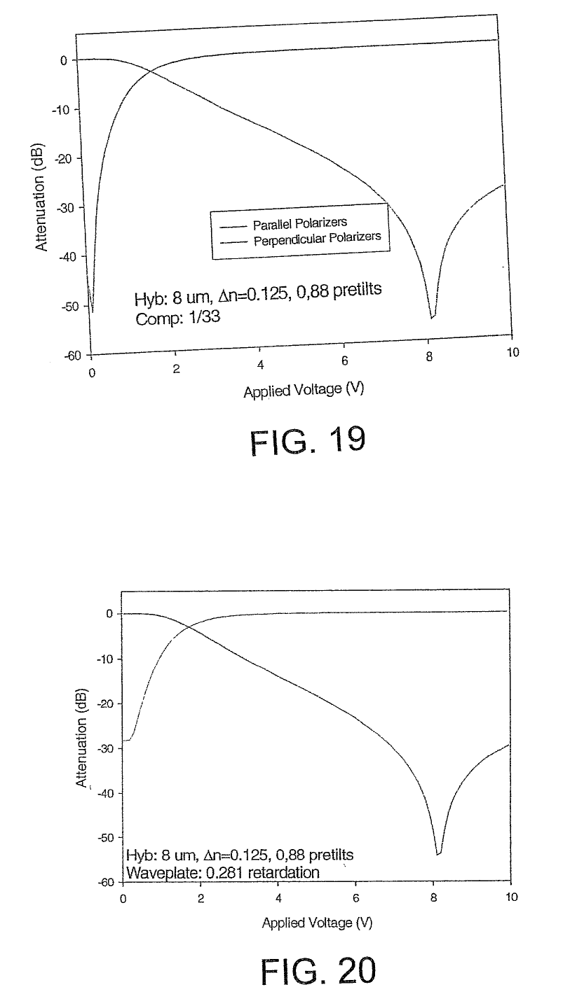

The HAN LC device 300 may be utilized in either of the configurations shown in FIG. 10 or 12. A simulation with the HAN LC device 300 as used in the configuration of FIG. 10 is shown in FIG. 19 whereas the results of a simulation using the third version in the configuration of FIG. 12 is shown in FIG. 20.

The LC devices disclosed above are advantageous in that they have little or no incident angle-dependent loss, they can attenuate to greater than 40 dB, and can be constructed to have a fairly small size.

As noted above, although three specific version of a reflective LC device are disclosed that may be used as reflective spatial light modulator 120, the present invention is not limited to optical systems employing these specific LC devices.

It will become apparent to those skilled in the art that various modifications to the preferred embodiment of the invention as described herein can be made without departing from the spirit or scope of the invention as defined by the appended claims.

The invention claimed is:

1. An optical system comprising:
a beam polarization combiner for receiving a first set of input beams and a second set of input beams, each beam in the first set of beams having a different wavelength and each beam in the second set of beams having a different wavelength and corresponding to a beam in the first set of beams; and
a reflective spatial light modulator having a plurality of individually activated modulating elements each corresponding to a respective one of the different wavelengths of the input beams, wherein each input beam is directed at a modulating element of corresponding wavelength with input beams of the first set impinging upon the corresponding modulating element from a first incoming path and input beams of the second set impinging upon the corresponding modulating element from a second incoming path, each modulating element selectively changes the polarization of, and reflects, the input beams such that a first outgoing path for each reflected beam of the first set is superimposed on the second incoming path and a second outgoing path for each reflected beam of the second set is superimposed on the first incoming path,
wherein said polarization beam combiner receives the reflected first and second sets of beams and directs the beams in different directions based upon the polarization of the beams as selectively imparted by said reflective spatial light modulator.

2. The optical system of claim 1, wherein said polarization beam combiner further receives a third set of input beams and a fourth set of input beams, the input beams of the third and fourth sets being polarized opposite that of the input beams of the first and second sets, each beam in the third set of beams having a different wavelength and each beam in the fourth set of beams having a different wavelength and corresponding to a beam in the third set of beams, and wherein each input beam of the third and fourth sets is directed at a modulating element of corresponding wavelength with input beams of the third set impinging upon the corresponding modulating element from the first incoming path and input beams of the fourth set impinging upon the corresponding modulating element from the second incoming path, each modulating element selectively changes the polarization of, and reflects, the input beams such that each reflected beam of the third set is output along the first outgoing path, which is superimposed on the second incoming path, and such that each reflected beam of the fourth set is output along the second outgoing path, which is superimposed on the first incoming path, wherein said polarization beam combiner receives the reflected third and fourth sets of beams and directs the beams in different directions based upon the polarization of the beams as selectively imparted by said reflective spatial light modulator.

3. The optical system of claim 2 and further comprising a lens disposed between said polarization beam combiner and said reflective spatial light modulator for focusing beams onto said reflective spatial modulator and for collimating reflected beams from said reflective spatial light modulator.

4. The optical system of claim 3 and further comprising a retarder disposed between said polarization beam combiner and said reflective spatial light modulator.

5. The optical system of claim 1 and further comprising a lens disposed between said polarization beam combiner and said reflective spatial light modulator, for focusing beams onto said reflective spatial modulator and for collimating reflected beams from said reflective spatial light modulator.

6. The optical system of claim 1, wherein said polarization beam combiner comprises one or more optical elements selected from a group consisting of a polarizing beam combining prism, a birefringent plate, polarizing prisms, and polarization beamsplitting slabs.

7. The optical system of claim 1, wherein said reflective spatial light modulator is selected from a group consisting of a reflective liquid crystal device, a pixellated birefringent crystal array, a plurality of MEMs devices, and an array of variable filters.

8. A dynamic spectral equalizer comprising:
a polarization beam separator for separating an input beam into first and second orthogonally polarized beamlets that are spatially separated from one another;
a dispersive element for dispersing said beamlets into a plurality of beamlet pairs each beamlet pair corresponding to different wavelengths; and
a reflective spatial light modulator having a plurality of individually activated modulating elements each corresponding to a respective one of the beamlet pairs, wherein each beamlet pair is directed at a corresponding modulating element with the two beamlets forming the pair respectively impinging upon the corresponding modulating element from two separate incoming paths, each modulating element selectively attenuates and reflects the beamlets such that an outgoing path for each polarized beamlet is superimposed on the incoming path for the other polarized beamlet of the beamlet pair.

9. The dynamic spectral equalizer of claim 8 and further comprising a lens for focusing the plurality of beamlet pairs onto said reflective spatial light modulator.

10. The dynamic spectral equalizer of claim 9, wherein, following selective reflection from a corresponding modulating element, the reflected beamlet pairs pass back through said lens where the reflected beamlets are collimated and directed back to said dispersion element, where the plurality of reflected beamlet pairs are recombined into two reflected beamlets based upon their original polarization upon separation by said polarization beam separator.

11. The dynamic spectral equalizer of claim 10, wherein the two reflected beamlets output from said dispersive element impinge upon said polarization beam separator, which recombines the two reflected beamlets to form an output beam.

12. The dynamic spectral equalizer of claim 11 and further comprising a common fiber having a first end from which the input beam is projected onto said polarization beam separator and into which the output beam is coupled.

13. The dynamic spectral equalizer of claim 12 and further comprising an input fiber, an output fiber, and a circulator coupled to said input, output and common fibers, said circulator receives the input beam from said input fiber and directs the input beam to said common fiber, said circulator further receiving the output beam from said common fiber and directs the output beam to said output fiber.

14. The dynamic spectral equalizer of claim 8 and further comprising a polarizer disposed in front of said reflective spatial light modulator.

15. The dynamic spectral equalizer of claim 8 and further comprising a polarizer disposed between said polarization beam separator and said dispersing element in the beam path of one of the two beamlets.

16. The dynamic spectral equalizer of claim 15, wherein said beamlets of each beamlet pair impinge upon the corresponding modulating element in equal and opposite angles with respect to a normal to the incident surface of the modulating element.

17. The dynamic spectral equalizer of claim 8 and further comprising a retarder disposed between said reflective spatial light modulator and said polarization beam combiner.

18. The dynamic spectral equalizer of claim 8, wherein said reflective spatial light modulator is selected from a group consisting of a reflective liquid crystal device, a pixellated birefringent crystal array, a plurality of MEM devices, and an array of variable filters.

19. The dynamic spectral equalizer of claim 8, wherein said reflective spatial light modulator is a reflective liquid crystal device.

20. The dynamic spectral equalizer of claim 8, wherein said polarization beam separator comprises one or more elements selected from the group consisting of a pair of beam polarizing beamsplitters, a birefringent plate, a polarizing prism, and a polarization beam splitting slab.

21. The dynamic spectral equalizer of claim 8, wherein said dispersive element is selected from a group consisting of a prism, a grating, and a grism.

22. A dynamic spectral equalizer comprising:
a first polarization beam separator for separating a first input beam into first and second orthogonally polarized beamlets that are spatially separated from one another;
a first polarization changer for changing the polarization of the first beamlet such that said first and second beamlets both have a first polarization;
a first dispersive element for separating each of the first and second beamlets into respective first and second sets of component beamlets corresponding to different wavelengths, each component beamlet in the first set having a corresponding component beamlet in the second set at the same wavelength;
a second polarization beam separator for separating a second input beam into third and fourth orthogonally polarized beamlets that are spatially separated from one another;
a second polarization changer for changing the polarization of one or both of the third and fourth beamlets such that said third and fourth beamlets both have a second polarization opposite the first polarization;
a second dispersive element for separating each of the third and fourth beamlets into respective third and fourth sets of component beamlets corresponding to different wavelengths, each component beamlet in the third set having a corresponding component beamlet in the fourth set at the same wavelength;
a polarization beam combiner for combining the first and third sets of component beamlets and the second and fourth sets of component beamlets; and
a reflective spatial light modulator having a plurality of individually activated modulating elements each corresponding to a respective one of the different wavelengths of the component beamlets, wherein each composite beamlet is directed at a modulating element of corresponding wavelength with component beamlets of the first and third set impinging upon the corresponding modulating element from a first incoming path and component beamlets of the second and fourth set impinging upon the corresponding modulating element from a second incoming path, each modulating element selectively attenuates and reflects the incident component beamlets such that a first outgoing path for each reflected component beamlet of the first and third sets are superimposed on the second incoming path and a second outgoing path for each reflected component beamlet of the second and fourth sets are superimposed on the first incoming path.

23. The dynamic spectral equalizer of claim 22, wherein each of the sets of reflected component beamlets are received by said polarization beam combiner, which separates the first and third sets of reflected component beamlets from one another and separates the second and fourth sets of reflected component beamlets from one another.

24. The dynamic spectral equalizer of claim 23, wherein said polarization beam combiner respectively redirects the first and second sets of reflected component beamlets along the path from which the second and first sets of component beamlets were received from said first dispersive element, and respectively redirects the third and fourth sets of reflected component beamlets along the path from which the fourth and third sets of component beamlets were received from said second dispersive element.

25. The dynamic spectral equalizer of claim 24, wherein said first dispersive element recombines the reflected component beamlets of the first and second sets to output first and second reflected beamlets, and wherein said second dispersive element recombines the reflected component beamlets of the third and fourth sets to output third and fourth reflected beamlets.

26. The dynamic spectral equalizer of claim 25, wherein said first polarization changer receives the second reflected beamlet and changes the polarization of the second reflected beamlet to be orthogonally polarized with respect to the first reflected beamlet, said second polarization changer receives one or both of the third and fourth beamlets and changes the polarization of the received reflected beamlet to be orthogonally polarized with respect to the other of the third and fourth reflected beamlet.

27. The dynamic spectral equalizer of claim 26, wherein said first polarization separator recombines the first and second orthogonally polarized reflected beamlets to provide a first output beam, and said first polarization separator recombines the third and fourth orthogonally polarized reflected beamlets to provide a second output beam.

28. The dynamic spectral equalizer of claim 27, wherein the first output beam is coupled to a first common fiber from which the first input beam was received, and the second output beam is coupled to a second common fiber from which the second input beam was received.

29. The dynamic spectral equalizer of claim 22 and further comprising a retarder disposed between said reflective spatial light modulator and said polarization beam combiner.

30. The dynamic spectral equalizer of claim 22, wherein said reflective spatial light modulator is selected from a group consisting of a reflective liquid crystal device, a pixellated birefringent crystal array, a plurality of MEMs devices, and an array of variable filters.

31. The dynamic spectral equalizer of claim 22, wherein said reflective spatial light modulator is a reflective liquid crystal device.

32. The dynamic spectral equalizer of claim 22, wherein said first and second polarization changers are selected from a group consisting of a polarization rotator, a retardation plate, a crystal rotator, and a liquid crystal.

33. The dynamic spectral equalizer of claim 22, wherein said first and second polarization beam separators comprise one or more elements selected from the group consisting of a pair of beam polarizing beamsplitters, a birefringent plate, a polarizing prism, and a polarization beam splitting slab.

34. The dynamic spectral equalizer of claim 22, wherein said first and second dispersive elements are selected from a group consisting of a prism, a grating, and a grism.

35. The dynamic spectral equalizer of claim 22, wherein said polarization beam combiner comprises one or more optical elements selected from a group consisting of a polarizing beam combining prism, a birefringent plate, polarizing prisms, and polarization beamsplitting slabs.

36. A wavelength selective switch comprising:
a first polarization beam separator for separating a first input composite beam into first and second orthogonally polarized composite beamlets that are spatially separated from one another;
a first polarization changer for changing the polarization of the first composite beamlet such that said first and second composite beamlets both have a first polarization;
a first dispersive element for separating each of the first and second composite beamlets into respective first and second sets of component beamlets corresponding to different wavelengths, each component beamlet in the first set having a corresponding component beamlet in the second set at the same wavelength and each such pair of component beamlets constituting a channel signal pair;
a second polarization beam separator for separating a second input composite beam into third and fourth orthogonally polarized composite beamlets that are spatially separated from one another;
a second polarization changer for changing the polarization of one or both of the third and fourth composite beamlets such that said third and fourth composite beamlets both have a second polarization opposite the first polarization;
a second dispersive element for separating each of the third and fourth composite beamlets into respective third and fourth sets of component beamlets corresponding to different wavelengths, each component beamlet in the third set having a corresponding component beamlet in the fourth set at the same wavelength and each such pair of component beamlets constituting a channel signal pair;
a polarization beam combiner for combining the first and third sets of component beamlets and the second and fourth sets of component beamlets; and
a reflective spatial light modulator having a plurality of individually activated modulating elements each corresponding to a respective one of the different wavelengths of the component beamlets and thereby each corresponding to a channel signal pair from the first input composite signal and a channel signal pair from the second input composite signal, wherein each composite beamlet is directed at a modulating element of corresponding wavelength with component beamlets of the first and third set impinging upon the corresponding modulating element from a first incoming path and component beamlets of the second and fourth set impinging upon the corresponding modulating element from a second incoming path, each modulating element selectively changes the polarization of the incident component beamlets such that the two impinging channel signal pairs have different polarizations, said reflective spatial light modulator also reflects the incident component beamlets such that a first outgoing path for each reflected component beamlet of the first and third sets are superimposed on the second incoming path and a second outgoing path for each reflected component beamlet of the second and fourth sets are superimposed on the first incoming path.

37. The wavelength selective switch of claim 36, wherein each of the sets of reflected component beamlets are received by said polarization beam combiner, which separates the sets of reflected component beamlets from one another and redirects the sets reflected component beamlets towards one of said first and second dispersive elements based upon their polarization as selectively modified by said reflective spatial light modulator, wherein the reflected component beamlets of a channel signal pair are redirected towards the same dispersive element.

38. The wavelength selective switch of claim 37, wherein said first dispersive element recombines the reflected component beamlets of the received sets to output first and second reflected composite beamlets, and wherein said second dispersive element recombines the reflected component beamlets of the third and fourth sets to output third and fourth reflected composite beamlets.

39. The wavelength selective switch of claim 38, wherein said first polarization changer receives the second reflected composite beamlet and changes the polarization of the second reflected composite beamlet to be orthogonally polarized with respect to the first reflected composite beamlet, said second polarization changer receives one or both of the third and fourth composite beamlets and changes the polarization of the received reflected composite beamlet to be orthogonally polarized with respect to the other of the third and fourth reflected composite beamlet.

40. The wavelength selective switch of claim 39, wherein said first polarization separator recombines the first and second orthogonally polarized reflected composite beamlets to provide a first output beam, and said first polarization separator recombines the third and fourth orthogonally polarized reflected composite beamlets to provide a second output beam.

41. The wavelength selective switch of claim 40, wherein the first output beam is coupled to a first common fiber from which the first input composite beam was received, and the second output beam is coupled to a second common fiber from which the second input composite beam was received.

42. The wavelength selective switch of claim 41 and further comprising:
a first input fiber through which the first input composite beam is transmitted;
a second input fiber through which the second input composite beam is transmitted;
a first output fiber;
a second output fiber;
a first circulator coupled to said first input fiber, said first output fiber, and said first common fiber, said first circulator receives the first input composite beam from said first input fiber and directs the first input composite beam to said first common fiber, said first circulator further receiving the first output beam from said first common fiber and directs the first output beam to said first output fiber; and
a second circulator coupled to said second input fiber, said second output fiber, and said second common fiber, said second circulator receives the second input composite beam from said second input fiber and directs the second input composite beam to said second common fiber, said second circulator further receiving the second output beam from said second common fiber and directs the second output beam to said second output fiber.

43. The wavelength selective switch of claim 36 and further comprising a lens disposed between said polarization beam combiner and said reflective spatial light modulator for focusing beams onto said reflective spatial modulator and for collimating reflected beams from said reflective spatial light modulator.
